(19) United States
(12) Patent Application Publication
(10) Pub. No.: US 2002/0128916 A1
(43) Pub. Date: Sep. 12, 2002

(54) Methods, apparatus and articles-of-manufacture for distributing/redeeming a universal incentive currency

(76) Inventor: Walter Beinecke III, Manchester, MA (US)

Correspondence Address: David Garrod, Ph.D., Esq., Hopgood, Calimafde, Judlowe & Mondolino, LLP, 60 East 42nd Street, New York, NY, 10165, US

(21) Appl. No.: 09/795,893

(22) Filed: Feb. 28, 2001

Related U.S. Application Data
(60) Provisional application No. 60/185,303, filed on Feb. 28, 2000.

(51) Int. Cl. G06F 17/60

(52) U.S. Cl. 705/26

(57) ABSTRACT

The invention relates to an Internet-accessible incentive marketing program, which provides a plurality of html pages viewable by Internet-connected users using browser software. This program provides a plurality of services that allow Internet-connected users to accrue and utilize incentive points. Generally, a homepage is provided, including various links, such as (i) an enrollment link, for initiating an on-line enrollment process, (ii) an informational link, for providing information concerning the incentive marketing program, (iii) a login link, for accessing user account information, (iv) a time-limited incentive link, for accessing a time-limited incentive offer, (v) an incentive-referral enrollment link, for directing the user to enroll in a third-party program from which the user can accrue incentive points, (vi) a direct-access shopping link, for permitting the user to transact on-line business with an associated merchant or service provider, and (vii) a direct-access redemption link, including an associated depiction of an award and an incentive point total needed to redeem the award, for permitting the user to redeem the depicted award. The third-party program associated with an incentive-referral enrollment link may, for example, relate to Internet access services, long-distance telephone services, on-line auction services, or other services.

### CROSS-REFERENCE TO RELATED APPLICATION

This application derives from U.S. Provisional Patent Application S/N 60/185,303, filed Feb. 28, 2000, which prior provisional application is hereby incorporated by reference.

### FIELD OF THE INVENTION

The present invention relates generally to the field of computer-assisted business methods, and to systems and articles-of-manufacture for implementing such methods. More particularly, the invention relates to computer-based methods, apparatus and articles-of-manufacture for implementing and/or operating loyalty rewards programs, and the like.

### BACKGROUND OF THE INVENTION

Incentive marking and loyalty rewards programs have existed for many years. An example is the well-known S&H Green Stamps program, wherein participants are awarded “Green Stamps” by participating merchants, in exchange for purchases or other qualifying activities. Once a participant collects a sufficient number of Green Stamps, he/she may redeem the Stamps for rewards, such as free merchandise, or other valuable consideration. Another familiar example of a loyalty rewards program is the “frequent flyer” program, wherein an airline awards points for flights on the particular airline, which points may eventually be redeemed for free travel on the particular airline.

With the widespread promulgation of computer technology in the business world, a variety of computer-implemented loyalty rewards programs have been reported, in recent years. For example, U.S. Pat. No. 5,483,444, SYSTEM FOR AWARDING CREDITS TO PERSONS WHO BOOK TRAVEL-RELATED RESERVATIONS, describes a system for rewarding agents and other persons, based on their on-line travel and/or hotel bookings. U.S. Pat. No. 5,025,372, SYSTEM AND METHOD FOR ADMINISTRATION OF INCENTIVE AWARD PROGRAM THROUGH USE OF CREDIT, discloses a system for rewarding credit card users by issuing “kickbacks” to the card-holder's account, with the size of the kickbacks being dependent on the amount of credit card use or interest paid by the customer. U.S. Pat. No. 5,710,887, COMPUTER SYSTEM AND METHOD FOR ELECTRONIC COMMERCE, describes a system that awards “frequent buyer points” to customers of an on-line shopping mall. As a final example, U.S. Pat. No. 5,056,019, AUTOMATED PURCHASE REWARD ACCOUNTING SYSTEM AND METHOD, discloses a system in which participants are credited with incentive reward points, for in-store purchases, through use of a bar-coded membership card which identifies the participant.

The above-mentioned '444, '372, '887 and '019 patents, each of which is incorporated herein by reference, evidence a current state-of-the-art in which incentive credits can be awarded, maintained and redeemed by computer, and in which participants in the incentive program can communicate with the computer (via, for example, the Internet) to check incentive point balances and redeem points for selected awards.

Despite the wide promulgation of computer-based loyalty-rewards systems, present-day systems suffer from a number of deficiencies that diminish their market acceptance and reduce their loyalty-influencing power. For example, present-day loyalty-rewards systems typically award incentive credits for a specific type of activity, such as on-line purchases at a particular web site, use of a specific credit or debit card, in-store purchases at particular stores, travel on particular carriers, etc. As a result, a consumer interested in taking maximum advantage of available incentives is forced to enroll in numerous programs, remember which program covers which activity (e.g., the “X” program covers in-store purchases, the “Y” program covers on-line purchases, etc.), and remember how and when to redeem the points earned in each of the various programs. This presents a frustrating situation to the average consumer, and is believed (by the inventor herein) to be a major impediment to the widespread use of loyalty rewards programs. Thus, there remains an unfulfilled need for a computer-based incentive program that better meets the requirements of consumers, yet provides all of the conveniences of today's fully-automated, on-line systems.

### OBJECTS AND DESCRIPTION OF THE INVENTION

In light of the above, one general object of the present invention is a computer-based method, apparatus and article-of-manufacture for implementing and/or operating a unified incentive/loyalty rewards system.

Another general object of the invention is a computer-based method, apparatus and article-of-manufacture for implementing and/or operating an incentive/loyalty rewards system in which participants can earn points from a wide variety of qualifying activities.

Yet another general object of the invention is a computer-based method, apparatus and article-of-manufacture for implementing and/or operating an incentive/loyalty rewards system in which the qualifying activities, for which participants are awarded points, include both off-line (e.g., in the store) purchases and on-line (e.g., through the Internet) purchases.

A further general object of the invention is a computer-based method, apparatus and article-of-manufacture for implementing and/or operating an incentive/loyalty rewards system which permits users to aggregate and assign their points to each other (e.g., a user may assign some or all of his/her points to another user, or to a group) and/or to charitable organizations (e.g., a school or national charity).

A still further general object of the invention is a computer-based method, apparatus and article-of-manufacture for implementing and/or operating an incentive/loyalty rewards system which permits users to redeem their points either on-line or off-line.

Still further objects of the invention relate to methods, apparatus and/or articles-of-manufacture to facilitate collection of customer behavior information when customers engage in incentive-accruing transactions or activities, and to utilize such information to target promotional offers.

These, and other objects/advantages, are realized by the present invention, which preferably comprises at least one server, connected to a computer network. The invention may also include a plurality of additional servers, to service such functions as offline redemption and/or regional points collection and accounting functions. Points may be earned for a wide variety of qualifying activities, including, but not limited to, on-line purchases, offline purchases, flights, hotel stays, credit/debit card use, participation in surveys, telephone use, banking activity, gasoline purchases, internet site visits, and on-line contests or lotteries. For purposes of redemption and/or qualification, users may be identified by a variety of means, including, but not limited to, on-line signatures (e.g., user id/password or cryptographic id), bar-coded identification cards, magnetic cards, smart cards, or biometric identifiers (e.g., fingerprint or iris pattern).

Accordingly, generally speaking, and without intending to be limiting, one aspect of the invention relates to a method for operating an Internet-accessible incentive marketing program, comprising the following: providing, via an Internet-accessible server, a plurality of html pages, including a homepage, the html pages viewable by Internet-connected users using browser software; providing, through the Internet-accessible server, a plurality of services that allow the Internet-connected users to accrue incentive points and to utilize accrued incentive points; providing, on the homepage, at least the following: (i) an enrollment link, selectable by an Internet-connected user to initiate an on-line enrollment process; (ii) an informational link, selectable by an Internet-connected user to provide information concerning the incentive marketing program; (iii) a login link, selectable by an Internet-connected user to access user account information; and (iv) at least two of the following: (a) at least one time-limited incentive link, selectable by an Internet-connected user to access a time-limited incentive offer; (b) at least one incentive-referral enrollment link, selectable by an Internet-connected user to direct the user to enroll in a third-party program from which the user can accrue incentive points; (c) a plurality of direct-access shopping links, each selectable by an Internet-connected user to permit the user to transact on-line business with an associated merchant or service provider, and accrue incentive points therefor; and (d) a plurality of direct-access redemption links, each including an associated depiction of an award and an incentive point total needed to redeem the award, the direct-access redemption links each selectable by an Internet-connected user to permit the user to redeem the depicted award. The third-party program associated with the at least one incentive-referral enrollment link may relate to Internet access services, long-distance telephone services, on-line auction services, or other services.

Again, generally speaking, and without intending to be limiting, another aspect of the invention relates to a method for operating an Internet-accessible incentive marketing program, comprising: providing, via an Internet-accessible server, a plurality of html pages, including a homepage, the html pages viewable by Internet-connected users using browser software; providing, through the Internet-accessible server, a plurality of services that allow the Internet-connected users to accrue incentive points and to utilize accrued incentive points; and providing, on the homepage, a brick-and-mortar customer referral link, selectable by an Internet-connected user to permit the user to utilize incentive points earned in connection with brick-and-mortar purchases. The method may further involve providing, on the homepage, at least one, two, three, or all of the following: (i) at least one time-limited incentive link, selectable by an Internet-connected user to access a time-limited incentive offer; (ii) at least one incentive-referral enrollment link, selectable by an Internet-connected user to direct the user to enroll in a third-party program from which the user can accrue incentive points; (iii) a plurality of direct-access shopping links, each selectable by an Internet-connected user to permit the user to transact on-line business with an associated merchant or service provider, and accrue incentive points therefor; and/or (iv) a plurality of direct-access redemption links, each including an associated depiction of an award and an incentive point total needed to redeem the award, the direct-access redemption links each selectable by an Internet-connected user to permit the user to redeem the depicted award.

Again, generally speaking, and without intending to be limiting, another aspect of the invention relates to a method for operating an Internet-accessible incentive point redemption system, comprising: maintaining, on an Internet-accessible server, data corresponding to a multiplicity of customer accounts; providing an Internet-accessible homepage through which an Internet-connected user can access the server to interrogate or utilize his/her account; providing, on the Internet-accessible homepage, a primary redemption link, selectable by an Internet-connected user to navigate the user to a redemption homepage; providing, on the redemption homepage, at least one, two, three or more of the following: (i) a charitable donation link, selectable by an Internet-connected user to initiate a process whereby the user can donate incentive points from his/her account to one or more charitable organizations; (ii) an assignment link, selectable by an Internet-connected user to initiate a process whereby the user can assign incentive points from his/her account to another user's account; (iii) a travel redemption link, selectable by an Internet-connected user to initiate a process whereby incentive points can be redeemed for travel services; (iv) an awards catalog search tool, engageable by an Internet-connected user to search an awards catalog by: (a) points required for redemption, (b) category of reward, or both (a) and (b); and (v) a plurality of direct-access redemption links, each including an associated depiction of an award, the direct-access redemption links each selectable by an Internet-connected user to permit the user to redeem the depicted award.

Again, generally speaking, and without intending to be limiting, another aspect of the invention relates to a method for operating an Internet-accessible incentive marketing program, comprising: providing, via an Internet-accessible server, a plurality of Web pages viewable by Internet-connected users using browser software; providing, through the Internet-accessible server, a plurality of services that allow the Internet-connected users to accrue incentive points and to utilize accrued incentive points; providing a Web homepage, having at least the following: (i) an enrollment link, selectable by an Internet-connected user to initiate an on-line enrollment process; (ii) an informational link, selectable by an Internet-connected user to provide information concerning the incentive marketing program; (iii) a login link, selectable by an Internet-connected user to access user account information; (iv) a redemption homepage link, selectable by an Internet-connected user to access a redemption homepage; and (v) at least one, two, three or more of the following: (a) at least one time-limited incentive link, selectable by an Internet-connected user to access a time-limited incentive offer; (b) at least one incentive-referral enrollment link, selectable by an Internet-connected user to enable the user to enroll in a third-party program from which the user can accrue incentive points; (c) at least one direct-access shopping link, selectable by an Internet-connected user to permit the user to transact on-line business with an associated merchant or service provider, and accrue incentive points based on the value of the transacted business; and (d) at least one direct-access redemption link, the direct-access redemption link including an associated depiction of an award and being selectable by an Internet-connected user to permit the user to redeem the depicted award; and providing, on the redemption homepage, at least one, two, three or more of the following: (a) a charitable donation link, selectable by an Internet-connected user to initiate a process whereby the user can donate incentive points from his/her account to one or more charitable organizations; (b) an assignment link, selectable by an Internet-connected user to initiate a process whereby the user can assign incentive points from his/her account to another user's account; (c) a travel redemption link, selectable by an Internet-connected user to initiate a process whereby incentive points can be redeemed for travel services; (d) an awards catalog search tool, engageable by an Internet-connected user to search a catalog of awards that can be obtained using incentive points; and (e) a plurality of direct-access redemption links, each including an associated depiction of an award, the direct-access redemption links each selectable by an Internet-connected user to permit the user to redeem the depicted award.

Again, generally speaking, and without intending to be limiting, another aspect of the invention relates to a method for operating an incentive marketing program, comprising: maintaining, in a database, a list of enrolled members and account information for each member, the account information including a current incentive point balance; identifying a customer as an enrolled member; using the database to determine, in real time, the identified customer's incentive point balance; using the identified customer's incentive point balance to determine whether the customer is eligible for a discount on goods being purchased by the customer and, if so, offering a discount to the customer in exchange for redemption of all or part of the customer's incentive point balance; and, in response to the customer's directive, redeeming all or part of the customer's incentive point balance to provide a purchase discount to the customer, updating the database to reflect the redemption, and providing a receipt to the customer that details the redemption and the purchase discount. Identifying a customer as an enrolled member may involve comparing data received from a magnetic stripe reader at the point-of-purchase to data stored in the database, comparing data received from an optical bar code reader at the point-of-purchase to data stored in the database, comparing data received from a smart card reader at the point-of-purchase to data stored in the database, or comparing data entered into a data entry device at the point-of-purchase to data stored in the database.

Again, generally speaking, and without intending to be limiting, another aspect of the invention relates to a method for operating an incentive marketing program, comprising: maintaining, in a database, a list of enrolled members and account information for each member, the account information including a current incentive point balance; identifying a customer, at a point-of-purchase location, as an enrolled member; using the database to determine, in real time, the identified customer's incentive point balance; determining whether any items that the identified customer has presented for purchase can be acquired or discounted through redemption of incentive point's in the customer's account and, if so, offering to redeem incentive points in exchange for discount(s) on, and/or acquisition(s)of, one or more items that the customer has presented for purchase.

Again, generally speaking, and without intending to be limiting, another aspect of the invention relates to a method of operating a universal incentive marketing program that permits registered users to accrue incentive points for both on-line and in-store transactions, comprising: maintaining a network-accessible central server that includes a database of account information for registered users; providing a customer identification device at a retail point-of-purchase location that permits identification of a customer as a registered user; adding incentive points to the accounts of customers identified as registered users for in-store purchases made by the users; providing an Internet-accessible homepage linked to the central server to permit identification of an Internet-connected user as a registered user, the homepage further including at least one, two or more of the following: (a) at least one time-limited incentive link, selectable by the user to access a time-limited incentive offer; (b) at least one incentive-referral enrollment link, selectable by the user to direct the user to enroll in a third-party program from which the user can accrue incentive points; (c) a plurality of direct-access shopping links, each selectable by the user to permit the user to transact on-line business with an associated merchant or service provider, and accrue incentive points therefor; and (d) a plurality of direct-access redemption links, each including an associated depiction of an award and an incentive point total needed to redeem the award, the direct-access redemption links each selectable by the user to permit the user to redeem the depicted award. The homepage may also include a link to a redemption homepage, and the redemption homepage includes at least one, two or more of the following: (a) a charitable donation link, selectable by the user to initiate a process whereby the user can donate incentive points from his/her account to one or more charitable organizations; (b) an assignment link, selectable by the user to initiate a process whereby the user can assign incentive points from his/her account to another user's account; (c) a travel redemption link, selectable by the user to initiate a process whereby incentive points can be redeemed for travel services; (d) an awards catalog search tool, engageable by the user to search a catalog of awards that can be obtained using incentive points; and (e) a plurality of direct-access redemption links, each including an associated depiction of an award, the direct-access redemption links each selectable by the user to permit the user to redeem the depicted award.

Again, generally speaking, and without intending to be limiting, another aspect of the invention relates to a methods, apparatus, or articles-of-manufacture for operating an incentive marketing program, and using collected customer data to target customer promotions by, for example, the following: maintaining, in a database, a list of enrolled members of said incentive marketing program; identifying, in real time, at a point-of-purchase location, a customer as an enrolled member; and determining, in real time, whether said customer is eligible to participate in a promotion and, if so, presenting the promotion to the customer. The promotion may involve one or more of: a discount on product(s) that the customer is purchasing; a discount on product(s) that the customer is purchasing, contingent upon the customer purchasing selected additional product(s); a pre-approved credit card offer; a discount travel offer; an offer to earn incentive points at an accelerated rate; and/or an offer to earn free merchandise if the customer makes additional purchases, satisfies certain conditions, or performs certain actions.

Again, generally speaking, and without intending to be limiting, another aspect of the invention relates to an Internet-accessible incentive marketing system, comprising: an Internet-accessible server, configured to serve a plurality of html pages, including a homepage, viewable by Internet-connected users using browser software; the server further configured to provide a plurality of services that allow the Internet-connected users to accrue incentive points and to utilize accrued incentive points; the homepage including a brick-and-mortar customer referral link, selectable by an Internet-connected user to permit the user to utilize incentive points earned in connection with brick-and-mortar purchases. The homepage may further include at least one, two or more of the following: (a) at least one time-limited incentive link, selectable by an Internet-connected user to access a time-limited incentive offer; (b) at least one incentive-referral enrollment link, selectable by an Internet-connected user to direct the user to enroll in a third-party program from which the user can accrue incentive points; (c) a plurality of direct-access shopping links, each selectable by an Internet-connected user to permit the user to transact on-line business with an associated merchant or service provider, and accrue incentive points therefor; and (d) a plurality of direct-access redemption links, each including an associated depiction of an award and an incentive point total needed to redeem the award, the direct-access redemption links each selectable by an Internet-connected user to permit the user to redeem the depicted award.

Again, generally speaking, and without intending to be limiting, another aspect of the invention relates to a universal incentive marketing system that permits registered users to accrue incentive points for both on-line and in-store transactions, comprising: a network-accessible central server that includes a database of account information for registered users; a customer identification device, comprising one of a bar code reader, a magnetic stripe reader, a smart card reader, or a manual data entry device, the customer identification device permitting identification of a customer as a registered user; an incentive point accounting module, configured to add incentive points to the accounts of customers identified as registered users for in-store purchases made by the users; and an Internet-accessible homepage linked to the central server to permit identification of an Internet-connected user as a registered user, the homepage further including at least one, two or more of the following: (a) at least one time-limited incentive link, selectable by the user to access a time-limited incentive offer; (b) at least one incentive-referral enrollment link, selectable by the user to direct the user to enroll in a third-party program from which the user can accrue incentive points; (c) a plurality of direct-access shopping links, each selectable by the user to permit the user to transact on-line business with an associated merchant or service provider, and accrue incentive points therefor; and (d) a plurality of direct-access redemption links, each including an associated depiction of an award and an incentive point total needed to redeem the award, the direct-access redemption links each selectable by the user to permit the user to redeem the depicted award. The homepage may also include a link to a redemption homepage, and the redemption homepage may include at least one, two or more of the following: (a) a charitable donation link, selectable by the user to initiate a process whereby the user can donate incentive points from his/her account to one or more charitable organizations; (b) an assignment link, selectable by the user to initiate a process whereby the user can assign incentive points from his/her account to another user's account; (c) a travel redemption link, selectable by the user to initiate a process whereby incentive points can be redeemed for travel services; (d) an awards catalog search tool, engageable by the user to search a catalog of awards that can be obtained using incentive points; and (e) a plurality of direct-access redemption links, each including an associated depiction of an award, the direct-access redemption links each selectable by the user to permit the user to redeem the depicted award.

Again, generally speaking, and without intending to be limiting, another aspect of the invention relates to an Internet-accessible incentive marketing system, comprising: an Internet-accessible server, configured to serve up a plurality of html pages, including a homepage, the html pages viewable by Internet-connected users using browser software; the Internet-accessible server further configured to serve up a plurality of services that allow the Internet-connected users to accrue incentive points and to utilize accrued incentive points; the homepage including at least the following: (a) an enrollment link, selectable by an Internet-connected user to initiate an on-line enrollment process; (b) an informational link, selectable by an Internet-connected user to provide information concerning the incentive marketing program; (c) a login link, selectable by an Internet-connected user to access user account information; and (d) at least one, two or more of the following: (e) at least one time-limited incentive link, selectable by an Internet-connected user to access a time-limited incentive offer; (f) at least one incentive-referral enrollment link, selectable by an Internet-connected user to direct the user to enroll in a third-party program from which the user can accrue incentive points; (g) a plurality of direct-access shopping links, each selectable by an Internet-connected user to permit the user to transact on-line business with an associated merchant or service provider, and accrue incentive points therefor; and (h) a plurality of direct-access redemption links, each including an associated depiction of an award and an incentive point total needed to redeem the award, the direct-access redemption links each selectable by an Internet-connected user to permit the user to redeem the depicted award. The at least one incentive-referral enrollment link may relate to Internet access services, long-distance telephone services, on-line auction services, or other services.

Again, generally speaking, and without intending to be limiting, another aspect of the invention relates to a method for operating an incentive marketing system, comprising: a database containing a list of enrolled members and account information for each member, the account information including a current incentive point balance; a customer identification device, located at a point-of-purchase, and configured to identify a customer as an enrolled member; a customer information query module, configured to query the database to determine, in real time, the identified customer's incentive point balance; and a point-of-purchase redemption processing module, configured to determine, in real time, whether any items that the identified customer has presented for purchase can be acquired or discounted through redemption of incentive point's in the customer's account and, if so, to present an offer to redeem incentive points in exchange for discount(s) on, and/or acquisition(s)of, one or more items that the customer has presented for purchase.

Again, generally speaking, and without intending to be limiting, another aspect of the invention relates to an Internet-accessible incentive point redemption system, comprising: an Internet-accessible server that stores data corresponding to a multiplicity of customer accounts; an Internet-accessible homepage through which an Internet-connected user can access the server to interrogate or utilize his/her account; the Internet-accessible homepage including a primary redemption link, selectable by an Internet-connected user to navigate the user to a redemption homepage; the redemption homepage including at least one, two or more of the following: (a) a charitable donation link, selectable by an Internet-connected user to initiate a process whereby the user can donate incentive points from his/her account to one or more charitable organizations; (b) an assignment link, selectable by an Internet-connected user to initiate a process whereby the user can assign incentive points from his/her account to another user's account; (c) a travel redemption link, selectable by an Internet-connected user to initiate a process whereby incentive points can be redeemed for travel services; (d) an awards catalog search tool, engageable by an Internet-connected user to search an awards catalog by: (i) points required for redemption, (ii) category of reward, or both (i) and (ii); and (e) a plurality of direct-access redemption links, each including an associated depiction of an award, the direct-access redemption links each selectable by an Internet-connected user to permit the user to redeem the depicted award.

Again, generally speaking, and without intending to be limiting, another aspect of the invention relates to an incentive marketing system, comprising: a database that includes a list of enrolled members and account information for each member, the account information including a current incentive point balance; means for identifying a customer as an enrolled member; means for using the database to determine, in real time, the identified customer's incentive point balance; means for using the identified customer's incentive point balance to determine whether the customer is eligible for a discount on goods being purchased by the customer and, if so, offering a discount to the customer in exchange for redemption of all or part of the customer's incentive point balance; and means, responsive to the customer's directive, for redeeming all or part of the customer's incentive point balance to provide a purchase discount to the customer, updating the database to reflect the redemption, and providing a receipt to the customer that details the redemption and the purchase discount. The means for identifying a customer as an enrolled member may comprise means for comparing data received from a magnetic stripe reader at the point-of-purchase to data stored in the database, means for comparing data received from an optical bar code reader at the point-of-purchase to data stored in the database, means for comparing data received from a smart card reader at the point-of-purchase to data stored in the database, or means for comparing data entered into a data entry device at the point-of-purchase to data stored in the database.

Again, generally speaking, and without intending to be limiting, another aspect of the invention relates to an Internet-accessible incentive marketing system, comprising: an Internet-accessible server, configured to serve up a plurality of Web pages viewable by Internet-connected users using browser software; the Internet-accessible server further configured to serve up a plurality of services that allow the Internet-connected users to accrue incentive points and to utilize accrued incentive points; a Web homepage, having at least some of the following: (a) an enrollment link, selectable by an Internet-connected user to initiate an on-line enrollment process; (b) an informational link, selectable by an Internet-connected user to provide information concerning the incentive marketing program; (c) a login link, selectable by an Internet-connected user to access user account information; (d) a redemption homepage link, selectable by an Internet-connected user to access a redemption homepage; and (e) at least one, two or more of the following: (f) at least one time-limited incentive link, selectable by an Internet-connected user to access a time-limited incentive offer; (g) at least one incentive-referral enrollment link, selectable by an Internet-connected user to enable the user to enroll in a third-party program from which the user can accrue incentive points; (h) at least one direct-access shopping link, selectable by an Internet-connected user to permit the user to transact on-line business with an associated merchant or service provider, and accrue incentive points based on the value of the transacted business; and (i) at least one direct-access redemption link, the direct-access redemption link including an associated depiction of an award and being selectable by an Internet-connected user to permit the user to redeem the depicted award; and a redemption homepage that includes at least one, two or more of the following: (a) a charitable donation link, selectable by an Internet-connected user to initiate a process whereby the user can donate incentive points from his/her account to one or more charitable organizations; (b) an assignment link, selectable by an Internet-connected user to initiate a process whereby the user can assign incentive points from his/her account to another user's account; (c) a travel redemption link, selectable by an Internet-connected user to initiate a process whereby incentive points can be redeemed for travel services; (d) an awards catalog search tool, engageable by an Internet-connected user to search a catalog of awards that can be obtained using incentive points; and (e) a plurality of direct-access redemption links, each including an associated depiction of an award, the direct-access redemption links each selectable by an Internet-connected user to permit the user to redeem the depicted award.

Again, generally speaking, and without intending to be limiting, another aspect of the invention relates to article(s)-of-manufacture for operating an incentive marketing program, the article(s)-of-manufacture comprising computer-readable media containing code which, when executed, causes a computer to: maintain, in a database, a list of enrolled members and account information for each member, the account information including a current incentive point balance; identify a customer, at a point-of-purchase location, as an enrolled member; use the database to determine, in real time, the identified customer's incentive point balance; determine, in real time, whether any items that the identified customer has presented for purchase can be acquired or discounted through redemption of incentive point's in the customer's account and, if so, offer to redeem incentive points in exchange for discount(s) on, and/or acquisition(s)of, one or more items that the customer has presented for purchase.

Again, generally speaking, and without intending to be limiting, another aspect of the invention relates to article(s)-of-manufacture for operating an Internet-accessible incentive marketing program, the article(s)-of-manufacture comprising computer-readable media containing code which, when executed, causes a computer to: provide, via an Internet-accessible server, a plurality of html pages, including a homepage, the html pages viewable by Internet-connected users using browser software; provide, through the Internet-accessible server, a plurality of services that allow the Internet-connected users to accrue incentive points and to utilize accrued incentive points; provide, on the homepage, at least the following: (a) an enrollment link, selectable by an Internet-connected user to initiate an on-line enrollment process; (b) an informational link, selectable by an Internet-connected user to provide information concerning the incentive marketing program; (c) a login link, selectable by an Internet-connected user to access user account information; and (d) at least two, three or more of the following: (e) at least one time-limited incentive link, selectable by an Internet-connected user to access a time-limited incentive offer; (f) at least one incentive-referral enrollment link, selectable by an Internet-connected user to direct the user to enroll in a third-party program from which the user can accrue incentive points; (g) a plurality of direct-access shopping links, each selectable by an Internet-connected user to permit the user to transact on-line business with an associated merchant or service provider, and accrue incentive points therefor; and (h) a plurality of direct-access redemption links, each including an associated depiction of an award and an incentive point total needed to redeem the award, the direct-access redemption links each selectable by an Internet-connected user to permit the user to redeem the depicted award.

Again, generally speaking, and without intending to be limiting, another aspect of the invention relates to article(s)-of-manufacture for operating a universal incentive marketing program that permits registered users to accrue incentive points for both on-line and in-store transactions, the article(s)-of-manufacture comprising computer-readable media containing code which, when executed, causes a computer to: maintain a network-accessible central server that includes a database of account information for registered users; receive data from a customer identification device at a retail point-of-purchase location, so as to permit identification of a customer as a registered user; add incentive points to the accounts of customers identified as registered users for in-store purchases made by the users; and provide an Internet-accessible homepage linked to the central server to permit identification of an Internet-connected user as a registered user, the homepage further including at least two of the following: (a) at least one time-limited incentive link, selectable by the user to access a time-limited incentive offer; (b) at least one incentive-referral enrollment link, selectable by the user to direct the user to enroll in a third-party program from which the user can accrue incentive points; (c) a plurality of direct-access shopping links, each selectable by the user to permit the user to transact on-line business with an associated merchant or service provider, and accrue incentive points therefor; and (d) a plurality of direct-access redemption links, each including an associated depiction of an award and an incentive point total needed to redeem the award, the direct-access redemption links each selectable by the user to permit the user to redeem the depicted award.

Again, generally speaking, and without intending to be limiting, another aspect of the invention relates to article(s)-of-manufacture for operating an Internet-accessible incentive point redemption system, the article(s)-of-manufacture comprising computer-readable media containing code which, when executed, causes a computer to: maintain, on an Internet-accessible server, data corresponding to a multiplicity of customer accounts; provide an Internet-accessible homepage through which an Internet-connected user can access the server to interrogate or utilize his/her account; provide, on the Internet-accessible homepage, a primary redemption link, selectable by an Internet-connected user to navigate the user to a redemption homepage; provide, on the redemption homepage, at least one, two or more of the following: (a) a charitable donation link, selectable by an Internet-connected user to initiate a process whereby the user can donate incentive points from his/her account to one or more charitable organizations; (b) an assignment link, selectable by an Internet-connected user to initiate a process whereby the user can assign incentive points from his/her account to another user's account; (c) a travel redemption link, selectable by an Internet-connected user to initiate a process whereby incentive points can be redeemed for travel services; (d) an awards catalog search tool, engageable by an Internet-connected user to search an awards catalog by: (i) points required for redemption, (ii) category of reward, or both (i) and (ii); and (e) a plurality of direct-access redemption links, each including an associated depiction of an award, the direct-access redemption links each selectable by an Internet-connected user to permit the user to redeem the depicted award.

Again, generally speaking, and without intending to be limiting, another aspect of the invention relates to article(s)-of-manufacture for operating an Internet-accessible incentive marketing program, the article(s)-of-manufacture comprising computer-readable media containing code which, when executed, causes a computer to: provide, via an Internet-accessible server, a plurality of html pages, including a homepage, the html pages viewable by Internet-connected users using browser software; provide, through the Internet-accessible server, a plurality of services that allow the Internet-connected users to accrue incentive points and to utilize accrued incentive points; and provide, on the homepage, a brick-and-mortar customer referral link, selectable by an Internet-connected user to permit the user to utilize incentive points earned in connection with brick-and-mortar purchases.

Again, generally speaking, and without intending to be limiting, another aspect of the invention relates to article(s)-of-manufacture for operating an incentive marketing program, the article(s)-of-manufacture comprising computer-readable media containing code which, when executed, causes a computer to: maintain, in a database, a list of enrolled members and account information for each member, the account information including a current incentive point balance; identify a customer as an enrolled member; query the database to determine, in real time, the identified customer's incentive point balance; use the identified customer's incentive point balance to determine whether the customer is eligible for a discount on goods being purchased by the customer and, if so, offer a discount to the customer in exchange for redemption of all or part of the customer's incentive point balance; and, in response to the customer's directive, redeem all or part of the customer's incentive point balance to provide a purchase discount to the customer, update the database to reflect the redemption, and provide a receipt to the customer that details the redemption and the purchase discount.

Again, generally speaking, and without intending to be limiting, another aspect of the invention relates to article(s)-of-manufacture for operating an Internet-accessible incentive marketing program, the article(s)-of-manufacture comprising computer-readable media containing code which, when executed, causes a computer to: provide, via an Internet-accessible server, a plurality of Web pages viewable by Internet-connected users using browser software; provide, through the Internet-accessible server, a plurality of services that allow the Internet-connected users to accrue incentive points and to utilize accrued incentive points; provide a Web homepage, having at least some of the following: (a) an enrollment link, selectable by an Internet-connected user to initiate an on-line enrollment process; (b) an informational link, selectable by an Internet-connected user to provide information concerning the incentive marketing program; (c) a login link, selectable by an Internet-connected user to access user account information; (d) a redemption homepage link, selectable by an Internet-connected user to access a redemption homepage; and at least some of the following: (a) at least one time-limited incentive link, selectable by an Internet-connected user to access a time-limited incentive offer; (b) at least one incentive-referral enrollment link, selectable by an Internet-connected user to enable the user to enroll in a third-party program from which the user can accrue incentive points; (c) at least one direct-access shopping link, selectable by an Internet-connected user to permit the user to transact on-line business with an associated merchant or service provider, and accrue incentive points based on the value of the transacted business; and (d) at least one direct-access redemption link, the direct-access redemption link including an associated depiction of an award and being selectable by an Internet-connected user to permit the user to redeem the depicted award; and provide, on the redemption homepage, at least some of the following: (a) a charitable donation link, selectable by an Internet-connected user to initiate a process whereby the user can donate incentive points from his/her account to one or more charitable organizations; (b) an assignment link, selectable by an Internet-connected user to initiate a process whereby the user can assign incentive points from his/her account to another user's account; (c) a travel redemption link, selectable by an Internet-connected user to initiate a process whereby incentive points can be redeemed for travel services; (d) an awards catalog search tool, engageable by an Internet-connected user to search a catalog of awards that can be obtained using incentive points; and (e) a plurality of direct-access redemption links, each including an associated depiction of an award, the direct-access redemption links each selectable by an Internet-connected user to permit the user to redeem the depicted award.

Still further aspects of the invention relate to alternative combinations, or sub-combinations, of the above-recited elements and/or actions, consistent with, or in furtherance of, one or more objectives of the present invention.

### BRIEF DESCRIPTION OF THE DRAWINGS

Various aspects, features and advantages of the instant invention are depicted in the accompanying set figures, which is intended to be illustrative, rather than limiting, and in which:

FIG. 1 depicts an illustrative embodiment of certain aspects of the present invention;

FIG. 2 depicts an alternative illustrative embodiment of certain aspects of the present invention;

FIGS. 3A-B collectively depict an illustrate embodiment of an Internet-accessible homepage in accordance with a preferred embodiment of the invention;

FIG. 4 depicts an illustrative embodiment of an Internet-accessible redemption homepage in accordance with a preferred embodiment of the invention; and,

FIG. 5 is a flowchart depicting an illustrative point-of-purchase redemption process in accordance with the present invention.

### DESCRIPTION OF THE PRESENTLY-PREFERRED EMBODIMENT

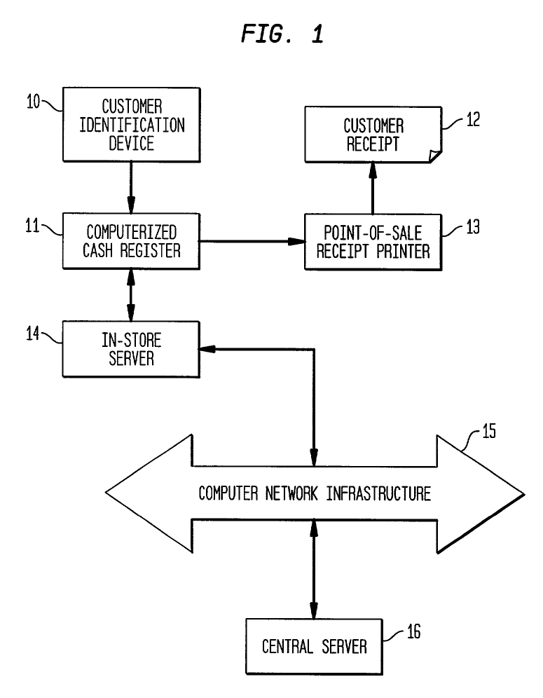

Referring initially to FIG. 1, a computerized cash register 11 receives customer ID data from a customer identification device 10 and queries an in-store server 14 to identify a customer as an incentive program participant. If the customer is identified as a participant, in-store server 14 retrieves relevant account information, including a current incentive point balance, for use in processing incentive point transactions.

In-store server 14 may store (or cache) local account data itself, or may retrieve requested data, as needed, from a central server 16. A computer network infrastructure 15 connects in-store server 14 and central server 16. Network infrastructure 15 preferably comprises a part of the Internet, but can also be any sort of private or semi-private WAN or LAN.

A point-of-sale receipt printer 13 permits generation of a customer receipt 12 containing various account information. Among the information that receipt 12 might contain is:

the customer's current incentive point balance;

a record of a customer's point-of-purchase redemption transaction;

promotions concerning new or additional ways that the customer can accrue incentive points;

promotions related to new or additional ways that the customer can redeem or use incentive points;

pre-approved credit card offers.

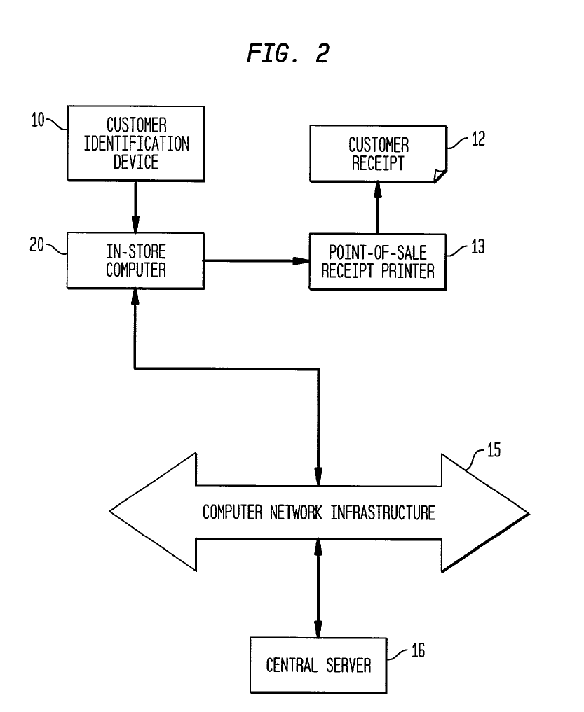

Referring now to FIG. 2, an alternative embodiment of the system depicted in FIG. 1 replaces computerized cash register 11 and in-store server 14 (which components are more typical of a large-store environment) with a single in-store computer 20. In-store computer 20 may comprise a personal computer, a computerized cash register, or any sort of computational device having the requisite data input and network interfacing capabilities. Using computer 20, one can perform all of the tasks necessary to operate an incentive program, in accordance with the present invention.

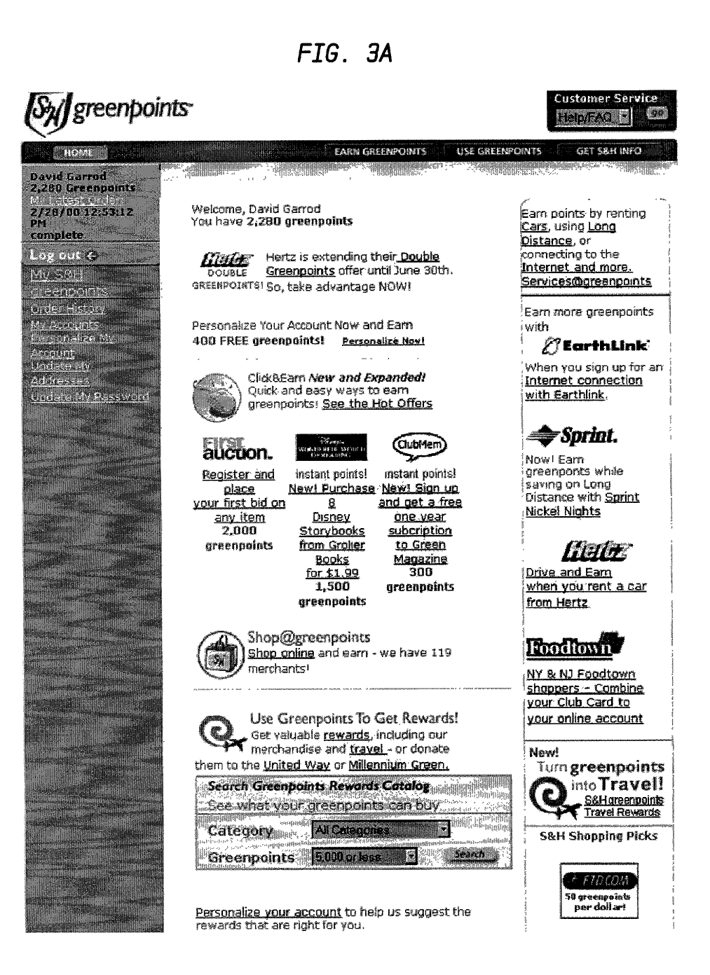

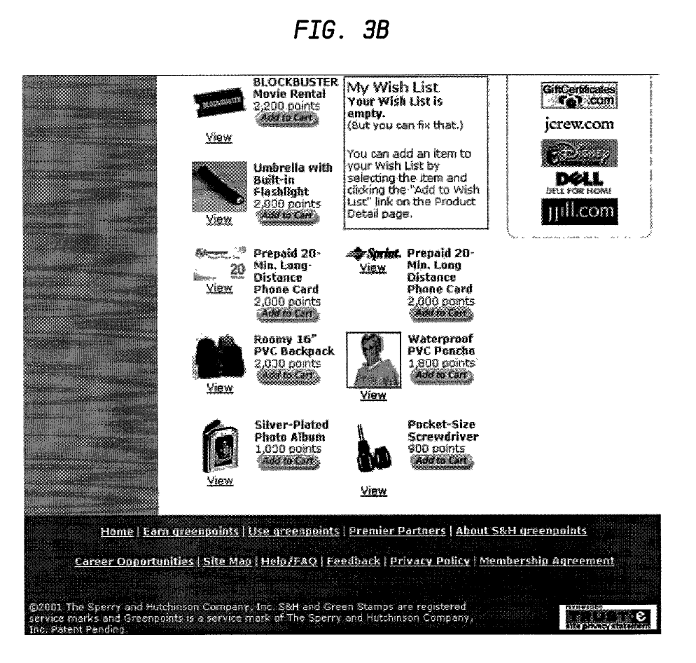

Referring now to FIGS. 3A-B, which collectively depict an illustrate embodiment of an Internet-accessible homepage in accordance with a preferred (“www.greenpoints.com”) embodiment of the invention, the depicted homepage includes:

an enrollment link (labeled “Enroll”), selectable by an Internet-connected user to initiate an on-line enrollment process;

a plurality of informational links (under heading “Here's how it works. . . ”), selectable by an Internet-connected user to provide information concerning the incentive marketing program;

a login link (labeled “−>Log in”), selectable by an Internet-connected user to access user account information;

at least one time-limited incentive link (labeled “Hertz is extending their Double Greenpoints offer until June 30th . . . ”), selectable by an Internet-connected user to access a time-limited incentive offer;

a plurality of incentive-referral enrollment links (e.g., those labeled “Internet connection with EarthLink,” and “Sprint Nickel Nights”), selectable by an Internet-connected user to direct the user to enroll in a third-party program from which the user can accrue incentive points;

a plurality of direct-access shopping links (e.g., those labeled “FTD.com,” “Sparks.com,” “Outpost.com,” etc.), each selectable by an Internet-connected user to permit the user to transact on-line business with an associated merchant or service provider, and accrue incentive points therefor;

a plurality of direct-access redemption links (e.g., those labeled “Silver-Plated Tea Box,” “Size 5 Tournament Soccer Ball,” etc.), each including an associated depiction of an award and an incentive point total needed to redeem the award, the direct-access redemption links each selectable by an Internet-connected user to permit the user to redeem the depicted award;

a brick-and-mortar customer referral link (labeled “Foodtown”), selectable by an Internet-connected user to permit the user to utilize incentive points earned in connection with brick-and-mortar purchases; and,

a primary redemption link (labeled “use greenpoints”), selectable by an Internet-connected user to navigate the user to a redemption homepage.

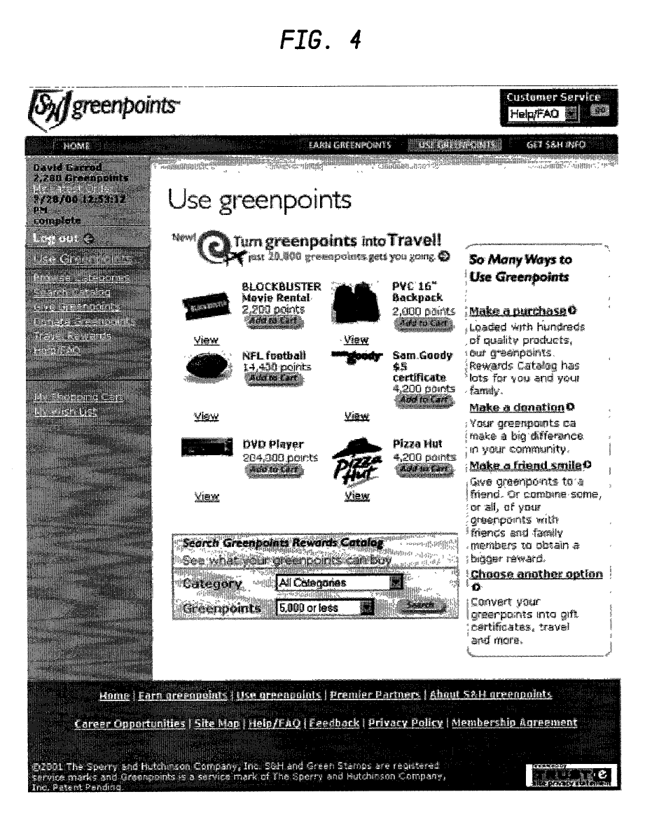

Referring now to FIG. 4, which depicts an illustrate embodiment of an Internet-accessible redemption homepage in accordance with a preferred (“www.greenpoints.com”) embodiment of the invention, the depicted redemption homepage includes:

a charitable donation link (labeled “Make a donation”), selectable by an Internet-connected user to initiate a process whereby the user can donate incentive points from his/her account to one or more charitable organizations;

an assignment link (labeled “Make a friend smile”), selectable by an Internet-connected user to initiate a process whereby the user can assign incentive points from his/her account to another user's account;

a travel redemption link (labeled “turn greenpoints into Travel!”), selectable by an Internet-connected user to initiate a process whereby incentive points can be redeemed for travel services;

an awards catalog search tool (labeled “Search Greenpoints Reward Catalog”), engageable by an Internet-connected user to search an awards catalog by: (i) points required for redemption, (ii) category of reward, or both (i) and (ii); and,

a plurality of direct-access redemption links (e.g., 5 those labeled “BLOCKBUSTER Movie Rental,” “Soft-Touch Volleyball,” etc.), each including an associated depiction of an award, the direct-access redemption links each selectable by an Internet-connected user to permit the user to redeem the depicted award.

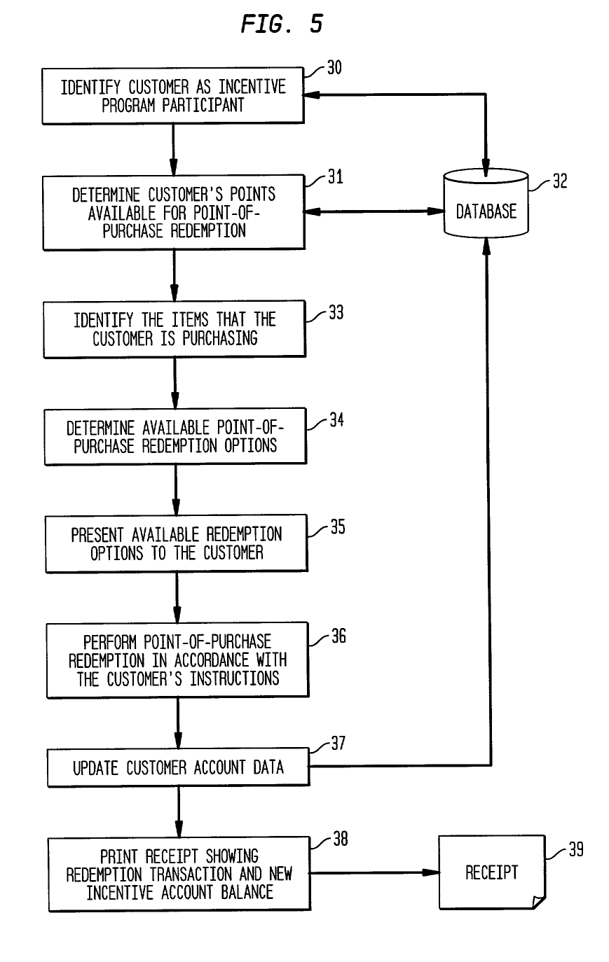

Referring now to FIG. 5, which shows a flowchart depicting an illustrative point-of-purchase redemption process in accordance with the present invention, the process begins by identifying 30 a customer as an incentive program participant. This is preferably done by comparing data from a customer identification device (such as a bar code scanner that reads a card presented by the customer) to data stored in database 32. Once the customer is identified as a participant, the number of available incentive points in the customer's account is determined 31, preferably by querying database 32.

The system then identifies 33 the items that the customer is presenting for purchase, and may also identify any incentive offers associated with the identified items. Next, all of the above information is processed to determine 34 (preferably in real time) the redemption options that may be available to the customer. Such redemption options may include, but are not limited to, discounts on certain items the customer is purchasing, cash rebates, movie passes, etc. The available redemption options are then presented 35 to the customer using, for example, a touch-screen display.

The customer then selects those redemption options that he/she wishes to exercise, and the system then executes 36 the selected redemptions. Finally, customer account data in database 32 is updated 37 to reflect the redemption(s), and a customer receipt is 39 is generated 38.

Those skilled in the art will appreciate that the invention may be alternatively implemented, and/or improved/enhanced, through use of a variety of presently-existing technologies. Thus, for example, it is within the scope of the present invention to permit users to access the www.greenpoints.com site via not only conventional, PC-type computers, but also cellular and wireless devices, palm-top computers, cable television set-top boxes, in-store kiosks, and the like.

Thus, while the invention has been described by recitation of its various aspects/features and an illustrative embodiment thereof, those skilled in the art will recognize that alternative elements and techniques, and/or combinations and sub-combinations of the described elements and techniques, can be substituted for, or added to, those described herein. The present invention, therefore, should not be limited to, or defined by, the specific apparatus, methods, and articles-of-manufacture described herein, but rather by the appended claims, which are intended to be construed in accordance with well-settled principles of claim construction, including, but not limited to, the following:

Limitations should not be read from the specification or drawings into the claims (e.g., if the claim calls for a “chair,” and the specification and drawings show a rocking chair, the claim term “chair” should not be limited to a rocking chair, but rather should be construed to cover any type of “chair”).

The words “comprising,” “including,” and “having” are always open-ended, irrespective of whether they appear as the primary transitional phrase of a claim, or as a transitional phrase within an element or sub-element of the claim (e.g., the claim “a widget comprising: A; B; and C” would be infringed by a device containing 2A's, B, and 3C's; also, the claim “a gizmo comprising: A; B, including X, Y, and Z; and C, having P and Q” would be infringed by a device containing 3A's, 2X's, 3Y's, Z, 6P's, and Q).

The indefinite articles “a” or “an” mean “one or more”;

where, instead, a purely singular meaning is intended, a phrase such as “one,” “only one,” or “a single,” will appear.

Where the phrase “means for” precedes a data processing or manipulation “function,” it is intended that the resulting means-plus-function element be construed to cover any, and all, computer implementation(s) of the recited “function” using any standard programming techniques known by, or available to, persons skilled in the computer programming arts.

A claim that contains more than one computer-implemented means-plus-function element should not be construed to require that each means-plus-function element must be a structurally distinct entity (such as a particular piece of hardware or block of code); rather, such claim should be construed merely to require that the overall combination of hardware/firmware/software which implements the invention must, as a whole, implement at least the function(s) called for by the claims.

What is claimed is:

1. A method for operating an Internet-accessible incentive marketing program, comprising:
providing, via an Internet-accessible server, a plurality of html pages, including a homepage, said html pages viewable by Internet-connected users using browser software;
providing, through said Internet-accessible server, a plurality of services that allow said Internet-connected users to accrue incentive points and to utilize accrued incentive points;
providing, on said homepage, at least the following:
an enrollment link, selectable by an Internet-connected user to initiate an on-line enrollment process;
an informational link, selectable by an Internet-connected user to provide information concerning said incentive marketing program;
a login link, selectable by an Internet-connected user to access user account information; and,
at least two of the following:
at least one time-limited incentive link, selectable by an Internet-connected user to access a time-limited incentive offer;
at least one incentive-referral enrollment link, selectable by an Internet-connected user to direct said user to enroll in a third-party program from which said user can accrue incentive points;
a plurality of direct-access shopping links, each selectable by an Internet-connected user to permit said user to transact on-line business with an associated merchant or service provider, and accrue incentive points therefor; and,
a plurality of direct-access redemption links, each including an associated depiction of an award and an incentive point total needed to redeem said award, said direct-access redemption links each selectable by an Internet-connected user to permit said user to redeem the depicted award.

2. A method for operating an Internet-accessible incentive marketing program, as defined in claim 1, wherein the third-party program associated with the at least one incentive-referral enrollment link relates to Internet access services.

3. A method for operating an Internet-accessible incentive marketing program, as defined in claim 1, wherein the third-party program associated with the at least one incentive-referral enrollment link relates to long-distance telephone services.

4. A method for operating an Internet-accessible incentive marketing program, as defined in claim 1, wherein the third-party program associated with the at least one incentive-referral enrollment link relates to on-line auction services.

5. A method for operating an Internet-accessible incentive marketing program, comprising:
providing, via an Internet-accessible server, a plurality of html pages, including a homepage, said html pages viewable by Internet-connected users using browser software;
providing, through said Internet-accessible server, a plurality of services that allow said Internet-connected users to accrue incentive points and to utilize accrued incentive points; and,
providing, on said homepage, a brick-and-mortar customer referral link, selectable by an Internet-connected user to permit said user to utilize incentive points earned in connection with brick-and-mortar purchases.

6. A method for operating an Internet-accessible incentive marketing program, as defined in claim 5, further including providing, on said homepage, at least one of the following:
at least one time-limited incentive link, selectable by an Internet-connected user to access a time-limited incentive offer;
at least one incentive-referral enrollment link, selectable by an Internet-connected user to direct said user to enroll in a third-party program from which said user can accrue incentive points;
a plurality of direct-access shopping links, each selectable by an Internet-connected user to permit said user to transact on-line business with an associated merchant or service provider, and accrue incentive points therefor; and/or,
a plurality of direct-access redemption links, each including an associated depiction of an award and an incentive point total needed to redeem said award, said direct-access redemption links each selectable by an Internet-connected user to permit said user to redeem the depicted award.

7. A method for operating an Internet-accessible incentive marketing program, as defined in claim 5, further including providing, on said homepage, at least two of the following:
at least one time-limited incentive link, selectable by an Internet-connected user to access a time-limited incentive offer;
at least one incentive-referral enrollment link, selectable by an Internet-connected user to direct said user to enroll in a third-party program from which said user can accrue incentive points;
a plurality of direct-access shopping links, each selectable by an Internet-connected user to permit said user to transact on-line business with an associated merchant or service provider, and accrue incentive points therefor; and,
a plurality of direct-access redemption links, each including an associated depiction of an award and an incentive point total needed to redeem said award, said direct-access redemption links each selectable by an Internet-connected user to permit said user to redeem the depicted award.

8. A method for operating an Internet-accessible incentive marketing program, as defined in claim 5, further including providing, on said homepage, at least three of the following:
at least one time-limited incentive link, selectable by an Internet-connected user to access a time-limited incentive offer;
at least one incentive-referral enrollment link, selectable by an Internet-connected user to direct said user to enroll in a third-party program from which said user can accrue incentive points;
a plurality of direct-access shopping links, each selectable by an Internet-connected user to permit said user to transact on-line business with an associated merchant or service provider, and accrue incentive points therefor; and,
a plurality of direct-access redemption links, each including an associated depiction of an award and an incentive point total needed to redeem said award, said direct-access redemption links each selectable by an Internet-connected user to permit said user to redeem the depicted award.

9. A method for operating an Internet-accessible incentive point redemption system, comprising:
maintaining, on an Internet-accessible server, data corresponding to a multiplicity of customer accounts;
providing an Internet-accessible homepage through which an Internet-connected user can access said server to interrogate or utilize his/her account;
providing, on said Internet-accessible homepage, a primary redemption link, selectable by an Internet-connected user to navigate said user to a redemption homepage;
providing, on said redemption homepage, at least two of the following:
a charitable donation link, selectable by an Internet-connected user to initiate a process whereby said user can donate incentive points from his/her account to one or more charitable organizations;
an assignment link, selectable by an Internet-connected user to initiate a process whereby said user can assign incentive points from his/her account to another user's account;
a travel redemption link, selectable by an Internet-connected user to initiate a process whereby incentive points can be redeemed for travel services;
an awards catalog search tool, engageable by an Internet-connected user to search an awards catalog by: (i) points required for redemption, (ii) category of reward, or both (i) and (ii);
a plurality of direct-access redemption links, each including an associated depiction of an award, said direct-access redemption links each selectable by an Internet-connected user to permit said user to redeem the depicted award.

10. A method for operating an Internet-accessible incentive point redemption system, as defined in claim 9, wherein said redemption homepage provides at least three of the following:
a charitable donation link, selectable by an Internet-connected user to initiate a process whereby said user can donate incentive points from his/her account to one or more charitable organizations;
an assignment link, selectable by an Internet-connected user to initiate a process whereby said user can assign incentive points from his/her account to another user's account;
a travel redemption link, selectable by an Internet-connected user to initiate a process whereby incentive points can be redeemed for travel services;
an awards catalog search tool, engageable by an Internet-connected user to search an awards catalog by: (i) points required for redemption, (ii) category of reward, or both (i) and (ii);
a plurality of direct-access redemption links, each including an associated depiction of an award, said direct-access redemption links each selectable by an Internet-connected user to permit said user to redeem the depicted award.

11. A method for operating an Internet-accessible incentive point redemption system, as defined in claim 9, wherein said redemption homepage provides at least four of the following:
a charitable donation link, selectable by an Internet-connected user to initiate a process whereby said user can donate incentive points from his/her account to one or more charitable organizations;
an assignment link, selectable by an Internet-connected user to initiate a process whereby said user can assign incentive points from his/her account to another user's account;
a travel redemption link, selectable by an Internet-connected user to initiate a process whereby incentive points can be redeemed for travel services;
an awards catalog search tool, engageable by an Internet-connected user to search an awards catalog by: (i) points required for redemption, (ii) category of reward, or both (i) and (ii);
a plurality of direct-access redemption links, each including an associated depiction of an award, said direct-access redemption links each selectable by an Internet-connected user to permit said user to redeem the depicted award.

12. A method for operating an Internet-accessible incentive marketing program, comprising:
providing, via an Internet-accessible server, a plurality of Web pages viewable by Internet-connected users using browser software;
providing, through said Internet-accessible server, a plurality of services that allow said Internet-connected users to accrue incentive points and to utilize accrued incentive points;
providing a Web homepage, having at least the following:
an enrollment link, selectable by an Internet-connected user to initiate an on-line enrollment process;
an informational link, selectable by an Internet-connected user to provide information concerning said incentive marketing program;
a login link, selectable by an Internet-connected user to access user account information;
a redemption homepage link, selectable by an Internet-connected user to access a redemption homepage; and,
at least one of the following:
at least one time-limited incentive link, selectable by an Internet-connected user to access a time-limited incentive offer;
at least one incentive-referral enrollment link, selectable by an Internet-connected user to enable said user to enroll in a third-party program from which said user can accrue incentive points;
at least one direct-access shopping link, selectable by an Internet-connected user to permit said user to transact on-line business with an associated merchant or service provider, and accrue incentive points based on the value of the transacted business; and,
at least one direct-access redemption link, said direct-access redemption link including an associated depiction of an award and being selectable by an Internet-connected user to permit said user to redeem the depicted award; and,
providing, on said redemption homepage, at least two of the following:
a charitable donation link, selectable by an Internet-connected user to initiate a process whereby said user can donate incentive points from his/her account to one or more charitable organizations;
an assignment link, selectable by an Internet-connected user to initiate a process whereby said user can assign incentive points from his/her account to another user's account;
a travel redemption link, selectable by an Internet-connected user to initiate a process whereby incentive points can be redeemed for travel services;
an awards catalog search tool, engageable by an Internet-connected user to search a catalog of awards that can be obtained using incentive points; and,
a plurality of direct-access redemption links, each including an associated depiction of an award, said direct-access redemption links each selectable by an Internet-connected user to permit said user to redeem the depicted award.

13. A method for operating an Internet-accessible incentive marketing program, as defined in claim 12:
wherein said Web homepage provides at least two of the following:
at least one time-limited incentive link, selectable by an Internet-connected user to access a time-limited incentive offer;
at least one incentive-referral enrollment link, selectable by an Internet-connected user to enable said user to enroll in a third-party program from which said user can accrue incentive points;
at least one direct-access shopping link, selectable by an Internet-connected user to permit said user to transact on-line business with an associated merchant or service provider, and accrue incentive points based on the value of the transacted business; and,
at least one direct-access redemption link, said direct-access redemption link including an associated depiction of an award and being selectable by an Internet-connected user to permit said user to redeem the depicted award;
and wherein said redemption homepage provides at least two of the following:
a charitable donation link, selectable by an Internet-connected user to initiate a process whereby said user can donate incentive points from his/her account to one or more charitable organizations;
an assignment link, selectable by an Internet-connected user to initiate a process whereby said user can assign incentive points from his/her account to another user's account;
a travel redemption link, selectable by an Internet-connected user to initiate a process whereby incentive points can be redeemed for travel services;
an awards catalog search tool, engageable by an Internet-connected user to search a catalog of awards that can be obtained using incentive points; and,
a plurality of direct-access redemption links, each including an associated depiction of an award, said direct-access redemption links each selectable by an Internet-connected user to permit said user to redeem the depicted award.

14. A method for operating an Internet-accessible incentive marketing program, as defined in claim 12:
wherein said Web homepage provides at least three of the following:
at least one time-limited incentive link, selectable by an Internet-connected user to access a time-limited incentive offer;
at least one incentive-referral enrollment link, selectable by an Internet-connected user to enable said user to enroll in a third-party program from which said user can accrue incentive points;
at least one direct-access shopping link, selectable by an Internet-connected user to permit said user to transact on-line business with an associated merchant or service provider, and accrue incentive points based on the value of the transacted business; and,
at least one direct-access redemption link, said direct-access redemption link including an associated depiction of an award and being selectable by an
Internet-connected user to permit said user to redeem the depicted award;
and wherein said redemption homepage provides at least two of the following:
a charitable donation link, selectable by an Internet-connected user to initiate a process whereby said user can donate incentive points from his/her account to one or more charitable organizations;
an assignment link, selectable by an Internet-connected user to initiate a process whereby said user can assign incentive points from his/her account to another user's account;
a travel redemption link, selectable by an Internet-connected user to initiate a process whereby incentive points can be redeemed for travel services;
an awards catalog search tool, engageable by an Internet-connected user to search a catalog of awards that can be obtained using incentive points; and,
a plurality of direct-access redemption links, each including an associated depiction of an award, said direct-access redemption links each selectable by an Internet-connected user to permit said user to redeem the depicted award.

15. A method for operating an Internet-accessible incentive marketing program, as defined in claim 12:
wherein said Web homepage provides at least two of the following:
at least one time-limited incentive link, selectable by an Internet-connected user to access a time-limited incentive offer;
at least one incentive-referral enrollment link, selectable by an Internet-connected user to enable said user to enroll in a third-party program from which said user can accrue incentive points;
at least one direct-access shopping link, selectable by an Internet-connected user to permit said user to transact on-line business with an associated merchant or service provider, and accrue incentive points based on the value of the transacted business; and,
at least one direct-access redemption link, said direct-access redemption link including an associated depiction of an award and being selectable by an Internet-connected user to permit said user to redeem the depicted award;
and wherein said redemption homepage provides at least three of the following:
a charitable donation link, selectable by an Internet-connected user to initiate a process whereby said user can donate incentive points from his/her account to one or more charitable organizations;
an assignment link, selectable by an Internet-connected user to initiate a process whereby said user can assign incentive points from his/her account to another user's account;
a travel redemption link, selectable by an Internet-connected user to initiate a process whereby incentive points can be redeemed for travel services;
an awards catalog search tool, engageable by an Internet-connected user to search a catalog of awards that can be obtained using incentive points; and,
a plurality of direct-access redemption links, each including an associated depiction of an award, said direct-access redemption links each selectable by an Internet-connected user to permit said user to redeem the depicted award.

16. A method for operating an Internet-accessible incentive marketing program, as defined in claim 12:
wherein said Web homepage provides at least three of the following:
at least one time-limited incentive link, selectable by an Internet-connected user to access a time-limited incentive offer;
at least one incentive-referral enrollment link, selectable by an Internet-connected user to enable said user to enroll in a third-party program from which said user can accrue incentive points;
at least one direct-access shopping link, selectable by an Internet-connected user to permit said user to transact on-line business with an associated merchant or service provider, and accrue incentive points based on the value of the transacted business; and,
at least one direct-access redemption link, said direct-access redemption link including an associated depiction of an award and being selectable by an Internet-connected user to permit said user to redeem the depicted award;
and wherein said redemption homepage provides at least three of the following:
a charitable donation link, selectable by an Internet-connected user to initiate a process whereby said user can donate incentive points from his/her account to one or more charitable organizations;
an assignment link, selectable by an Internet-connected user to initiate a process whereby said user can assign incentive points from his/her account to another user's account;
a travel redemption link, selectable by an Internet-connected user to initiate a process whereby incentive points can be redeemed for travel services;
an awards catalog search tool, engageable by an Internet-connected user to search a catalog of awards that can be obtained using incentive points; and,
a plurality of direct-access redemption links, each including an associated depiction of an award, said direct-access redemption links each selectable by an Internet-connected user to permit said user to redeem the depicted award.

17. A method for operating an incentive marketing program, comprising:
maintaining, in a database, a list of enrolled members and account information for each member, said account information including a current incentive point balance;
identifying a customer as an enrolled member;
using the database to determine, in real time, the identified customer's incentive point balance;
using the identified customer's incentive point balance to determine whether the customer is eligible for a discount on goods being purchased by the customer and, if so, offering a discount to the customer in exchange for redemption of all or part of the customer's incentive point balance; and,
in response to the customer's directive, redeeming all or part of the customer's incentive point balance to provide a purchase discount to the customer, updating the database to reflect the redemption, and providing a receipt to the customer that details the redemption and the purchase discount.

18. A method for operating an incentive marketing program, as defined in claim 17, wherein identifying a customer as an enrolled member comprises comparing data received from a magnetic stripe reader at the point-of-purchase to data stored in the database.

19. A method for operating an incentive marketing program, as defined in claim 17, wherein identifying a customer as an enrolled member comprises comparing data received from an optical bar code reader at the point-of-purchase to data stored in the database.

20. A method for operating an incentive marketing program, as defined in claim 17, wherein identifying a customer as an enrolled member comprises comparing data received from a smart card reader at the point-of-purchase to data stored in the database.

21. A method for operating an incentive marketing program, as defined in claim 17, wherein identifying a customer as an enrolled member comprises comparing data entered into a data entry device at the point-of-purchase to data stored in the database.

22. A method for operating an incentive marketing program, comprising:
maintaining, in a database, a list of enrolled members and account information for each member, said account information including a current incentive point balance;
identifying a customer, at a point-of-purchase location, as an enrolled member; using the database to determine, in real time, the identified customer's incentive point balance;
determining whether any items that the identified customer has presented for purchase can be acquired or discounted through redemption of incentive point's in the customer's account and, if so, offering to redeem incentive points in exchange for discount(s) on, and/or acquisition(s)of, one or more items that the customer has presented for purchase.

23. A method of operating a universal incentive marketing program that permits registered users to accrue incentive points for both on-line and in-store transactions, comprising:
maintaining a network-accessible central server that includes a database of account information for registered users;
providing a customer identification device at a retail point-of-purchase location that permits identification of a customer as a registered user;
adding incentive points to the accounts of customers identified as registered users for in-store purchases made by said users;
providing an Internet-accessible homepage linked to the central server to permit identification of an Internet-connected user as a registered user, the homepage further including at least two of the following:
at least one time-limited incentive link, selectable by the user to access a time-limited incentive offer;
at least one incentive-referral enrollment link, selectable by the user to direct said user to enroll in a third-party program from which said user can accrue incentive points;
a plurality of direct-access shopping links, each selectable by the user to permit said user to transact on-line business with an associated merchant or service provider, and accrue incentive points therefor; and,
a plurality of direct-access redemption links, each including an associated depiction of an award and an incentive point total needed to redeem said award, said direct-access redemption links each selectable by the user to permit said user to redeem the depicted award.

24. A method of operating a universal incentive marketing program, as defined in claim 23, wherein the homepage includes at least three of the following:
at least one time-limited incentive link, selectable by the user to access a time-limited incentive offer;
at least one incentive-referral enrollment link, selectable by the user to direct said user to enroll in a third-party program from which said user can accrue incentive points;
a plurality of direct-access shopping links, each selectable by the user to permit said user to transact on-line business with an associated merchant or service provider, and accrue incentive points therefor; and,
a plurality of direct-access redemption links, each including an associated depiction of an award and an incentive point total needed to redeem said award, said direct-access redemption links each selectable by the user to permit said user to redeem the depicted award.

25. A method of operating a universal incentive marketing program, as defined in claim 23, wherein the homepage includes:
at least one time-limited incentive link, selectable by the user to access a time-limited incentive offer; at least one incentive-referral enrollment link, selectable by the user to direct said user to enroll in a third-party program from which said user can accrue incentive points;
at least one direct-access shopping link, selectable by the user to permit said user to transact on-line business with an associated merchant or service provider, and accrue incentive points therefor; and,
a plurality of direct-access redemption links, each including an associated depiction of an award and an incentive point total needed to redeem said award, said direct-access redemption links each selectable the user to permit said user to redeem the depicted award.

26. A method of operating a universal incentive marketing program, as defined in claim 23, wherein the homepage includes a link to a redemption homepage, and the redemption homepage includes at least two of the following:
a charitable donation link, selectable by the user to initiate a process whereby said user can donate incentive points from his/her account to one or more charitable organizations;
an assignment link, selectable by the user to initiate a process whereby said user can assign incentive points from his/her account to another user's account;
a travel redemption link, selectable by the user to initiate a process whereby incentive points can be redeemed for travel services;
an awards catalog search tool, engageable by the user to search a catalog of awards that can be obtained using incentive points; and,
a plurality of direct-access redemption links, each including an associated depiction of an award, said direct-access redemption links each selectable by the user to permit said user to redeem the depicted award.

27. A method of operating a universal incentive marketing program, as defined in claim 23, wherein the homepage includes a link to a redemption homepage, and the redemption homepage includes at least three of the following:
a charitable donation link, selectable by the user to initiate a process whereby said user can donate incentive points from his/her account to one or more charitable organizations;
an assignment link, selectable by the user to initiate a process whereby said user can assign incentive points from his/her account to another user's account;
a travel redemption link, selectable by the user to initiate a process whereby incentive points can be redeemed for travel services;
an awards catalog search tool, engageable by the user to search a catalog of awards that can be obtained using incentive points; and,
a plurality of direct-access redemption links, each including an associated depiction of an award, said direct-access redemption links each selectable by the user to permit said user to redeem the depicted award.

28. A method of operating a universal incentive marketing program, as defined in claim 23, wherein the homepage includes a link to a redemption homepage, and the redemption homepage includes at least two of the following:
a charitable donation link, selectable by the user to initiate a process whereby said user can donate incentive points from his/her account to one or more charitable organizations;
an assignment link, selectable by the user to initiate a process whereby said user can assign incentive points from his/her account to another user's account;
a travel redemption link, selectable by the user to initiate a process whereby incentive points can be redeemed for travel services;
an awards catalog search tool, engageable by the user to search a catalog of awards that can be obtained using incentive points; and,
a plurality of direct-access redemption links, each including an associated depiction of an award, said direct-access redemption links each selectable by the user to permit said user to redeem the depicted award.

29. An Internet-accessible incentive marketing system, comprising:
an Internet-accessible server, configured to serve a plurality of html pages, including a homepage, viewable by Internet-connected users using browser software;
said server further configured to provide a plurality of services that allow said Internet-connected users to accrue incentive points and to utilize accrued incentive points;
said homepage including a brick-and-mortar customer referral link, selectable by an Internet-connected user to permit said user to utilize incentive points earned in connection with brick-and-mortar purchases.

30. An Internet-accessible incentive marketing system, as defined in claim 29, wherein said homepage further includes at least one of the following:
at least one time-limited incentive link, selectable by an Internet-connected user to access a time-limited incentive offer;
at least one incentive-referral enrollment link, selectable by an Internet-connected user to direct said user to enroll in a third-party program from which said user can accrue incentive points;
a plurality of direct-access shopping links, each selectable by an Internet-connected user to permit said user to transact on-line business with an associated merchant or service provider, and accrue incentive points therefor; and/or,
a plurality of direct-access redemption links, each including an associated depiction of an award and an incentive point total needed to redeem said award, said direct-access redemption links each selectable by an Internet-connected user to permit said user to redeem the depicted award.

31. An Internet-accessible incentive marketing system, as defined in claim 29, wherein said homepage further includes at least two of the following:
at least one time-limited incentive link, selectable by an Internet-connected user to access a time-limited incentive offer;
at least one incentive-referral enrollment link, selectable by an Internet-connected user to direct said user to enroll in a third-party program from which said user can accrue incentive points;
a plurality of direct-access shopping links, each selectable by an Internet-connected user to permit said user to transact on-line business with an associated merchant or service provider, and accrue incentive points therefor; and,
a plurality of direct-access redemption links, each including an associated depiction of an award and an incentive point total needed to redeem said award, said direct-access redemption links each selectable by an Internet-connected user to permit said user to redeem the depicted award.

32. An Internet-accessible incentive marketing system, as defined in claim 29, wherein said homepage further includes at least three of the following:
at least one time-limited incentive link, selectable by an Internet-connected user to access a time-limited incentive offer;
at least one incentive-referral enrollment link, selectable by an Internet-connected user to direct said user to enroll in a third-party program from which said user can accrue incentive points;
a plurality of direct-access shopping links, each selectable by an Internet-connected user to permit said user to transact on-line business with an associated merchant or service provider, and accrue incentive points therefor; and,
a plurality of direct-access redemption links, each including an associated depiction of an award and an incentive point total needed to redeem said award, said direct-access redemption links each selectable by an Internet-connected user to permit said user to redeem the depicted award.

33. A universal incentive marketing system that permits registered users to accrue incentive points for both on-line and in-store transactions, comprising:
a network-accessible central server that includes a database of account information for registered users;
a customer identification device, comprising one of a bar code reader, a magnetic stripe reader, a smart card reader, or a manual data entry device, the customer identification device permitting identification of a customer as a registered user;
an incentive point accounting module, configured to add incentive points to the accounts of customers identified as registered users for in-store purchases made by said users; and,
an Internet-accessible homepage linked to the central server to permit identification of an Internet-connected user as a registered user, the homepage further including at least two of the following:
at least one time-limited incentive link, selectable by the user to access a time-limited incentive offer;
at least one incentive-referral enrollment link, selectable by the user to direct said user to enroll in a third-party program from which said user can accrue incentive points;
a plurality of direct-access shopping links, each selectable by the user to permit said user to transact on-line business with an associated merchant or service provider, and accrue incentive points therefor; and,
a plurality of direct-access redemption links, each including an associated depiction of an award and an incentive point total needed to redeem said award, said direct-access redemption links each selectable by the user to permit said user to redeem the depicted award.

34. A universal incentive marketing system, as defined in claim 33, wherein the homepage includes at least three of the following:
at least one time-limited incentive link, selectable by the user to access a time-limited incentive offer;
at least one incentive-referral enrollment link, selectable by the user to direct said user to enroll in a third-party program from which said user can accrue incentive points;
a plurality of direct-access shopping links, each selectable by the user to permit said user to transact on-line business with an associated merchant or service provider, and accrue incentive points therefor; and,
a plurality of direct-access redemption links, each including an associated depiction of an award and an incentive point total needed to redeem said award, said direct-access redemption links each selectable by the user to permit said user to redeem the depicted award.

35. A universal incentive marketing system, as defined in claim 33, wherein the homepage includes:
at least one time-limited incentive link, selectable by the user to access a time-limited incentive offer;
at least one incentive-referral enrollment link, selectable by the user to direct said user to enroll in a third-party program from which said user can accrue incentive points;
at least one direct-access shopping link, selectable by the user to permit said user to transact on-line business with an associated merchant or service provider, and accrue incentive points therefor; and,
a plurality of direct-access redemption links, each including an associated depiction of an award and an incentive point total needed to redeem said award, said direct-access redemption links each selectable the user to permit said user to redeem the depicted award.

36. A universal incentive marketing system, as defined in claim 33, wherein the homepage includes a link to a redemption homepage, and the redemption homepage includes at least two of the following:
a charitable donation link, selectable by the user to initiate a process whereby said user can donate incentive points from his/her account to one or more charitable organizations;
an assignment link, selectable by the user to initiate a process whereby said user can assign incentive points from his/her account to another user's account;
a travel redemption link, selectable by the user to initiate a process whereby incentive points can be redeemed for travel services;
an awards catalog search tool, engageable by the user to search a catalog of awards that can be obtained using incentive points; and,
a plurality of direct-access redemption links, each including an associated depiction of an award, said direct-access redemption links each selectable by the user to permit said user to redeem the depicted award.

37. A universal incentive marketing system, as defined in claim 33, wherein the homepage includes a link to a redemption homepage, and the redemption homepage includes at least three of the following:
a charitable donation link, selectable by the user to initiate a process whereby said user can donate incentive points from his/her account to one or more charitable organizations;
an assignment link, selectable by the user to initiate a process whereby said user can assign incentive points from his/her account to another user's account;
a travel redemption link, selectable by the user to initiate a process whereby incentive points can be redeemed for travel services;
an awards catalog search tool, engageable by the user to search a catalog of awards that can be obtained using incentive points; and,
a plurality of direct-access redemption links, each including an associated depiction of an award, said direct-access redemption links each selectable by the user to permit said user to redeem the depicted award.

38. A method of operating a universal incentive marketing system, as defined in claim 33, wherein the homepage includes a link to a redemption homepage, and the redemption homepage includes at least two of the following:
a charitable donation link, selectable by the user to initiate a process whereby said user can donate incentive points from his/her account to one or more charitable organizations;
an assignment link, selectable by the user to initiate a process whereby said user can assign incentive points from his/her account to another user's account;
a travel redemption link, selectable by the user to initiate a process whereby incentive points can be redeemed for travel services;
an awards catalog search tool, engageable by the user to search a catalog of awards that can be obtained using incentive points; and,
a plurality of direct-access redemption links, each including an associated depiction of an award, said direct-access redemption links each selectable by the user to permit said user to redeem the depicted award.

39. An Internet-accessible incentive marketing system, comprising:
an Internet-accessible server, configured to serve up a plurality of html pages, including a homepage, said html pages viewable by Internet-connected users using browser software;
said Internet-accessible server further configured to serve up a plurality of services that allow said Internet-connected users to accrue incentive points and to utilize accrued incentive points;
said homepage including at least the following:
an enrollment link, selectable by an Internet-connected user to initiate an on-line enrollment process;
an informational link, selectable by an Internet5 connected user to provide information concerning said incentive marketing program;
a login link, selectable by an Internet-connected user to access user account information; and,
at least two of the following:
at least one time-limited incentive link, selectable by an Internet-connected user to access a time-limited incentive offer;
at least one incentive-referral enrollment link, selectable by an Internet-connected user to direct said user to enroll in a third-party program from which said user can accrue incentive points;
a plurality of direct-access shopping links, each selectable by an Internet-connected user to permit said user to transact on-line business with an associated merchant or service provider, and accrue incentive points therefor; and,
a plurality of direct-access redemption links, each including an associated depiction of an award and an incentive point total needed to redeem said award, said direct-access redemption links each selectable by an Internet-connected user to permit said user to redeem the depicted award.

40. An Internet-accessible incentive marketing system, as defined in claim 39, wherein the third-party program associated with the at least one incentive-referral enrollment link relates to Internet access services.

41. An Internet-accessible incentive marketing system, as defined in claim 39, wherein the third-party program associated with the at least one incentive-referral enrollment link relates to long-distance telephone services.

42. An Internet-accessible incentive marketing system, as defined in claim 39, wherein the third-party program associated with the at least one incentive-referral enrollment link relates to on-line auction services.

43. A method for operating an incentive marketing system, comprising:
a database containing a list of enrolled members and account information for each member, said account information including a current incentive point balance;
a customer identification device, located at a point-of-purchase, and configured to identify a customer as an enrolled member;
a customer information query module, configured to query said database to determine, in real time, the identified customer's incentive point balance; and,
a point-of-purchase redemption processing module, configured to determine, in real time, whether any items that the identified customer has presented for purchase can be acquired or discounted through redemption of incentive point's in the customer's account and, if so, to present an offer to redeem incentive points in exchange for discount(s) on, and/or acquisition(s)of, one or more items that the customer has presented for purchase.

44. An Internet-accessible incentive point redemption system, comprising:
an Internet-accessible server that stores data corresponding to a multiplicity of customer accounts;
an Internet-accessible homepage through which an Internet-connected user can access said server to interrogate or utilize his/her account;
said Internet-accessible homepage including a primary redemption link, selectable by an Internet-connected user to navigate said user to a redemption homepage;
said redemption homepage including at least two of the following:
a charitable donation link, selectable by an Internet-connected user to initiate a process whereby said user can donate incentive points from his/her account to one or more charitable organizations;
an assignment link, selectable by an Internet-connected user to initiate a process whereby said user can assign incentive points from his/her account to another user's account;
a travel redemption link, selectable by an Internet-connected user to initiate a process whereby incentive points can be redeemed for travel services;
an awards catalog search tool, engageable by an Internet-connected user to search an awards catalog by: (i) points required for redemption, (ii) category of reward, or both (i) and (ii);
a plurality of direct-access redemption links, each including an associated depiction of an award, said direct-access redemption links each selectable by an Internet-connected user to permit said user to redeem the depicted award.

45. An Internet-accessible incentive point redemption system, as defined in claim 44, wherein said redemption homepage provides at least three of the following:
a charitable donation link, selectable by an Internet-connected user to initiate a process whereby said user can donate incentive points from his/her account to one or more charitable organizations;
an assignment link, selectable by an Internet-connected user to initiate a process whereby said user can assign incentive points from his/her account to another user's account;
a travel redemption link, selectable by an Internet-connected user to initiate a process whereby incentive points can be redeemed for travel services;
an awards catalog search tool, engageable by an Internet-connected user to search an awards catalog by: (i) points required for redemption, (ii) category of reward, or both (i) and (ii);
a plurality of direct-access redemption links, each including an associated depiction of an award, said direct-access redemption links each selectable by an Internet-connected user to permit said user to redeem the depicted award.

46. An Internet-accessible incentive point redemption system, as defined in claim 44, wherein said redemption homepage provides at least four of the following:
a charitable donation link, selectable by an Internet-connected user to initiate a process whereby said user can donate incentive points from his/her account to one or more charitable organizations;
an assignment link, selectable by an Internet-connected user to initiate a process whereby said user can assign incentive points from his/her account to another user's account;
a travel redemption link, selectable by an Internet-connected user to initiate a process whereby incentive points can be redeemed for travel services;
an awards catalog search tool, engageable by an Internet-connected user to search an awards catalog by: (i) points required for redemption, (ii) category of reward, or both (i) and (ii);
a plurality of direct-access redemption links, each including an associated depiction of an award, said direct-access redemption links each selectable by an Internet-connected user to permit said user to redeem the depicted award.

47. An incentive marketing system, comprising:
a database that includes a list of enrolled members and account information for each member, said account information including a current incentive point balance;
means for identifying a customer as an enrolled member;
means for using the database to determine, in real time, the identified customer's incentive point balance;
means for using the identified customer's incentive point balance to determine whether the customer is eligible for a discount on goods being purchased by the customer and, if so, offering a discount to the customer in exchange for redemption of all or part of the customer's incentive point balance; and,
means, responsive to the customer's directive, for redeeming all or part of the customer's incentive point balance to provide a purchase discount to the customer, updating the database to reflect the redemption, and providing a receipt to the customer that details the redemption and the purchase discount.

48. An incentive marketing system, as defined in claim 47, wherein the means for identifying a customer as an enrolled member comprises means for comparing data received from a magnetic stripe reader at the point-of-purchase to data stored in the database.

49. An incentive marketing system, as defined in claim 47, wherein the means for identifying a customer as an enrolled member comprises means for comparing data received from an optical bar code reader at the point-of-purchase to data stored in the database.

50. An incentive marketing system, as defined in claim 47, wherein the means for identifying a customer as an enrolled member comprises means for comparing data received from a smart card reader at the point-of-purchase to data stored in the database.

51. An incentive marketing system, as defined in claim 47, wherein the means for identifying a customer as an enrolled member comprises means for comparing data entered into a data entry device at the point-of-purchase to data stored in the database.

52. An Internet-accessible incentive marketing system, comprising:
an Internet-accessible server, configured to serve up a plurality of Web pages viewable by Internet-connected users using browser software;
said Internet-accessible server further configured to serve up a plurality of services that allow said Internet-connected users to accrue incentive points and to utilize accrued incentive points;
a Web homepage, having at least the following:
an enrollment link, selectable by an Internet-connected user to initiate an on-line enrollment process;
an informational link, selectable by an Internet-connected user to provide information concerning said incentive marketing program;
a login link, selectable by an Internet-connected user to access user account information;
a redemption homepage link, selectable by an Internet-connected user to access a redemption homepage; and,
at least one of the following:
at least one time-limited incentive link, selectable by an Internet-connected user to access a time-limited incentive offer;
at least one incentive-referral enrollment link, selectable by an Internet-connected user to enable said user to enroll in a third-party program from which said user can accrue incentive points;
at least one direct-access shopping link, selectable by an Internet-connected user to permit said user to transact on-line business with an associated merchant or service provider, and accrue incentive points based on the value of the transacted business; and,
at least one direct-access redemption link, said direct-access redemption link including an associated depiction of an award and being selectable by an Internet-connected user to permit said user to redeem the depicted award; and,
a redemption homepage that includes at least two of the following:
a charitable donation link, selectable by an Internet-connected user to initiate a process whereby said user can donate incentive points from his/her account to one or more charitable organizations;
an assignment link, selectable by an Internet-connected user to initiate a process whereby said user can assign incentive points from his/her account to another user's account;
a travel redemption link, selectable by an Internet-connected user to initiate a process whereby incentive points can be redeemed for travel services;
an awards catalog search tool, engageable by an Internet-connected user to search a catalog of awards that can be obtained using incentive points; and,
a plurality of direct-access redemption links, each including an associated depiction of an award, said direct-access redemption links each selectable by an Internet-connected user to permit said user to redeem the depicted award.

53. An Internet-accessible incentive marketing system, as defined in claim 52:
wherein said Web homepage includes at least two of the following:
at least one time-limited incentive link, selectable by an Internet-connected user to access a time-limited incentive offer;
at least one incentive-referral enrollment link, selectable by an Internet-connected user to enable said user to enroll in a third-party program from which said user can accrue incentive points;
at least one direct-access shopping link, selectable by an Internet-connected user to permit said user to transact on-line business with an associated merchant or service provider, and accrue incentive points based on the value of the transacted business; and,
at least one direct-access redemption link, said direct-access redemption link including an associated depiction of an award and being selectable by an Internet-connected user to permit said user to redeem the depicted award;
and wherein said redemption homepage includes at least two of the following:
a charitable donation link, selectable by an Internet-connected user to initiate a process whereby said user can donate incentive points from his/her account to one or more charitable organizations;
an assignment link, selectable by an Internet-connected user to initiate a process whereby said user can assign incentive points from his/her account to another user's account;
a travel redemption link, selectable by an Internet-connected user to initiate a process whereby incentive points can be redeemed for travel services;
an awards catalog search tool, engageable by an Internet-connected user to search a catalog of awards that can be obtained using incentive points; and,
a plurality of direct-access redemption links, each including an associated depiction of an award, said direct-access redemption links each selectable by an Internet-connected user to permit said user to redeem the depicted award.

54. An Internet-accessible incentive marketing system, as defined in claim 52:
wherein said Web homepage includes at least three of the following:
at least one time-limited incentive link, selectable by an Internet-connected user to access a time-limited incentive offer;
at least one incentive-referral enrollment link, selectable by an Internet-connected user to enable said user to enroll in a third-party program from which said user can accrue incentive points;
at least one direct-access shopping link, selectable by an Internet-connected user to permit said user to transact on-line business with an associated merchant or service provider, and accrue incentive points based on the value of the transacted business; and,
at least one direct-access redemption link, said direct-access redemption link including an associated depiction of an award and being selectable by an Internet-connected user to permit said user to redeem the depicted award;
and wherein said redemption homepage includes at least two of the following:
a charitable donation link, selectable by an Internet-connected user to initiate a process whereby said user can donate incentive points from his/her account to one or more charitable organizations;
an assignment link, selectable by an Internet-connected user to initiate a process whereby said user can assign incentive points from his/her account to another user's account;
a travel redemption link, selectable by an Internet-connected user to initiate a process whereby incentive points can be redeemed for travel services;
an awards catalog search tool, engageable by an Internet-connected user to search a catalog of awards that can be obtained using incentive points; and,
a plurality of direct-access redemption links, each including an associated depiction of an award, said direct-access redemption links each selectable by an Internet-connected user to permit said user to redeem the depicted award.

55. An Internet-accessible incentive marketing system, as defined in claim 52:
wherein said Web homepage includes at least two of the following:
at least one time-limited incentive link, selectable by an Internet-connected user to access a time-limited incentive offer;
at least one incentive-referral enrollment link, selectable by an Internet-connected user to enable said user to enroll in a third-party program from which said user can accrue incentive points;
at least one direct-access shopping link, selectable by an Internet-connected user to permit said user to transact on-line business with an associated merchant or service provider, and accrue incentive points based on the value of the transacted business; and,
at least one direct-access redemption link, said direct-access redemption link including an associated depiction of an award and being selectable by an Internet-connected user to permit said user to redeem the depicted award;
and wherein said redemption homepage includes at least three of the following:
a charitable donation link, selectable by an Internet-connected user to initiate a process whereby said user can donate incentive points from his/her account to one or more charitable organizations;
an assignment link, selectable by an Internet-connected user to initiate a process whereby said user can assign incentive points from his/her account to another user's account;
a travel redemption link, selectable by an Internet-connected user to initiate a process whereby incentive points can be redeemed for travel services;
an awards catalog search tool, engageable by an Internet-connected user to search a catalog of awards that can be obtained using incentive points; and,
a plurality of direct-access redemption links, each including an associated depiction of an award, said direct-access redemption links each selectable by an Internet-connected user to permit said user to redeem the depicted award.

56. A method for operating an Internet-accessible incentive marketing system, as defined in claim 52:
wherein said Web homepage includes at least three of the following:
at least one time-limited incentive link, selectable by an Internet-connected user to access a time-limited incentive offer;
at least one incentive-referral enrollment link, selectable by an Internet-connected user to enable said user to enroll in a third-party program from which said user can accrue incentive points;
at least one direct-access shopping link, selectable by an Internet-connected user to permit said user to transact on-line business with an associated merchant or service provider, and accrue incentive points based on the value of the transacted business; and,
at least one direct-access redemption link, said direct-access redemption link including an associated depiction of an award and being selectable by an Internet-connected user to permit said user to redeem the depicted award;
and wherein said redemption homepage includes at least three of the following:
a charitable donation link, selectable by an Internet-connected user to initiate a process whereby said user can donate incentive points from his/her account to one or more charitable organizations;
an assignment link, selectable by an Internet-connected user to initiate a process whereby said user can assign incentive points from his/her account to another user's account;
a travel redemption link, selectable by an Internet-connected user to initiate a process whereby incentive points can be redeemed for travel services;
an awards catalog search tool, engageable by an Internet-connected user to search a catalog of awards that can be obtained using incentive points; and,
a plurality of direct-access redemption links, each including an associated depiction of an award, said direct-access redemption links each selectable by an Internet-connected user to permit said user to redeem the depicted award.

57. Article(s)-of-manufacture for operating an incentive marketing program, the article(s)-of-manufacture comprising computer-readable media containing code which, when executed, causes a computer to:
maintain, in a database, a list of enrolled members and account information for each member, said account information including a current incentive point balance;
identify a customer, at a point-of-purchase location, as an enrolled member;
use the database to determine, in real time, the identified customer's incentive point balance;
determine, in real time, whether any items that the identified customer has presented for purchase can be acquired or discounted through redemption of incentive point's in the customer's account and, if so, offer to redeem incentive points in exchange for discount(s) on, and/or acquisition(s) of, one or more items that the customer has presented for purchase.

58. Article(s)-of-manufacture for operating an Internet-accessible incentive marketing program, the article(s)-of-manufacture comprising computer-readable media containing code which, when executed, causes a computer to:
provide, via an Internet-accessible server, a plurality of html pages, including a homepage, said html pages viewable by Internet-connected users using browser software;
provide, through said Internet-accessible server, a plurality of services that allow said Internet-connected users to accrue incentive points and to utilize accrued incentive points;
provide, on said homepage, at least the following:
an enrollment link, selectable by an Internet-connected user to initiate an on-line enrollment process;
an informational link, selectable by an Internet-connected user to provide information concerning said incentive marketing program;
a login link, selectable by an Internet-connected user to access user account information; and,
at least three of the following:
at least one time-limited incentive link, selectable by an Internet-connected user to access a time-limited incentive offer;
at least one incentive-referral enrollment link, selectable by an Internet-connected user to direct said user to enroll in a third-party program from which said user can accrue incentive points;
a plurality of direct-access shopping links, each selectable by an Internet-connected user to permit said user to transact on-line business with an associated merchant or service provider, and accrue incentive points therefor; and,
a plurality of direct-access redemption links, each including an associated depiction of an award and an incentive point total needed to redeem said award, said direct-access redemption links each selectable by an Internet-connected user to permit said user to redeem the depicted award.

59. Article(s)-of-manufacture for operating a universal incentive marketing program that permits registered users to accrue incentive points for both on-line and in-store transactions, the article(s)-of-manufacture comprising computer-readable media containing code which, when executed, causes a computer to:
maintain a network-accessible central server that includes a database of account information for registered users;
receive data from a customer identification device at a retail point-of-purchase location, so as to permit identification of a customer as a registered user;
add incentive points to the accounts of customers identified as registered users for in-store purchases made by said users; and,
provide an Internet-accessible homepage linked to the central server to permit identification of an Internet-connected user as a registered user, the homepage further including at least two of the following:
at least one time-limited incentive link, selectable by the user to access a time-limited incentive offer;
at least one incentive-referral enrollment link, selectable by the user to direct said user to enroll in a third-party program from which said user can accrue incentive points;
a plurality of direct-access shopping links, each selectable by the user to permit said user to transact on-line business with an associated merchant or service provider, and accrue incentive points therefor; and,
a plurality of direct-access redemption links, each including an associated depiction of an award and an incentive point total needed to redeem said award, said direct-access redemption links each selectable by the user to permit said user to redeem the depicted award.

60. Article(s)-of-manufacture for operating an Internet-accessible incentive point redemption system, the article(s)-of-manufacture comprising computer-readable media containing code which, when executed, causes a computer to:
maintain, on an Internet-accessible server, data corresponding to a multiplicity of customer accounts;
provide an Internet-accessible homepage through which an Internet-connected user can access said server to interrogate or utilize his/her account;
provide, on said Internet-accessible homepage, a primary redemption link, selectable by an Internet-connected user to navigate said user to a redemption homepage;
provide, on said redemption homepage, at least two of the following:
a charitable donation link, selectable by an Internet-connected user to initiate a process whereby said user can donate incentive points from his/her account to one or more charitable organizations;
an assignment link, selectable by an Internet-connected user to initiate a process whereby said user can assign incentive points from his/her account to another user's account;
a travel redemption link, selectable by an Internet-connected user to initiate a process whereby incentive points can be redeemed for travel services;
an awards catalog search tool, engageable by an Internet-connected user to search an awards catalog by: (i) points required for redemption, (ii) category of reward, or both (i) and (ii); and,
a plurality of direct-access redemption links, each including an associated depiction of an award, said direct-access redemption links each selectable by an Internet-connected user to permit said user to redeem the depicted award.

61. Article(s)-of-manufacture for operating an Internet-accessible incentive marketing program, the article(s)-of-manufacture comprising computer-readable media containing code which, when executed, causes a computer to:
provide, via an Internet-accessible server, a plurality of html pages, including a homepage, said html pages viewable by Internet-connected users using browser software;
provide, through said Internet-accessible server, a plurality of services that allow said Internet-connected users to accrue incentive points and to utilize accrued incentive points; and,
provide, on said homepage, a brick-and-mortar customer referral link, selectable by an Internet-connected user to permit said user to utilize incentive points earned in connection with brick-and-mortar purchases.

62. Article(s)-of-manufacture for operating an incentive marketing program, the article(s)-of-manufacture comprising computer-readable media containing code which, when executed, causes a computer to:
maintain, in a database, a list of enrolled members and account information for each member, said account information including a current incentive point balance;
identify a customer as an enrolled member;
query the database to determine, in real time, the identified customer's incentive point balance;
use the identified customer's incentive point balance to determine whether the customer is eligible for a discount on goods being purchased by the customer and, if so, offer a discount to the customer in exchange for redemption of all or part of the customer's incentive point balance; and,
in response to the customer's directive, redeem all or part of the customer's incentive point balance to provide a purchase discount to the customer, update the database to reflect the redemption, and provide a receipt to the customer that details the redemption and the purchase discount.

63. Article(s)-of-manufacture for operating an Internet-accessible incentive marketing program, the article(s)-of-manufacture comprising computer-readable media containing code which, when executed, causes a computer to:
provide, via an Internet-accessible server, a plurality of Web pages viewable by Internet-connected users using browser software;
provide, through said Internet-accessible server, a plurality of services that allow said Internet-connected users to accrue incentive points and to utilize accrued incentive points;
provide a Web homepage, having at least the following:
an enrollment link, selectable by an Internet-connected user to initiate an on-line enrollment process;
an informational link, selectable by an Internet-connected user to provide information concerning said incentive marketing program;
a login link, selectable by an Internet-connected user to access user account information;
a redemption homepage link, selectable by an Internet-connected user to access a redemption homepage; and,
at least two of the following:
at least one time-limited incentive link, selectable by an Internet-connected user to access a time-limited incentive offer;
at least one incentive-referral enrollment link, selectable by an Internet-connected user to enable said user to enroll in a third-party program from which said user can accrue incentive points;
at least one direct-access shopping link, selectable by an Internet-connected user to permit said user to transact on-line business with an associated merchant or service provider, and accrue incentive points based on the value of the transacted business; and,
at least one direct-access redemption link, said direct-access redemption link including an associated depiction of an award and being selectable by an Internet-connected user to permit said user to redeem the depicted award; and,
provide, on said redemption homepage, at least two of the following:
a charitable donation link, selectable by an Internet-connected user to initiate a process whereby said user can donate incentive points from his/her account to one or more charitable organizations;
an assignment link, selectable by an Internet-connected user to initiate a process whereby said user can assign incentive points from his/her account to another user's account;
a travel redemption link, selectable by an Internet-connected user to initiate a process whereby incentive points can be redeemed for travel services;
an awards catalog search tool, engageable by an Internet-connected user to search a catalog of awards that can be obtained using incentive points; and,
a plurality of direct-access redemption links, each including an associated depiction of an award, said direct-access redemption links each selectable by an Internet-connected user to permit said user to redeem the depicted award.

64. A method for operating an incentive marketing program, comprising:
maintaining, in a database, a list of enrolled members of said incentive marketing program;
identifying, in real time, at a point-of-purchase location, a customer as an enrolled member;
determining, in real time, whether said customer is eligible to participate in a promotion and, if so, presenting the promotion to the customer.

65. A method for operating an incentive marketing program, as defined in claim 64, wherein said promotion comprises one or more of:
a discount on product(s) that the customer is purchasing;
a discount on product(s) that the customer is purchasing, contingent upon the customer purchasing selected additional product(s);
a pre-approved credit card offer;
a discount travel offer;
an offer to earn incentive points at an accelerated rate; and/or,
an offer to earn free merchandise if the customer makes additional purchases, satisfies certain conditions, or performs certain actions.
